(19) United States
(12) Patent Application Publication
(10) Pub. No.: US 2009/0140516 A1
(43) Pub. Date: Jun. 4, 2009

(54) Pipe saddle

(76) Inventors: L. Herbert King, JR., Chesterfield, MO (US); James Keeven, O'Fallon, MO (US); Steven Rhea, St. Peters, MO (US)

Correspondence Address: Carl L. Johnson;Jacobson and Johnson, Suite 285, One West Water Street, St. Paul, MN, 55107-2080, US

(21) Appl. No.: 11/998,290

(22) Filed: Nov. 29, 2007

(51) Int. Cl. F16L 41/00

(52) U.S. Cl. 285/197; 285/420; 285/5

(57) ABSTRACT

A pipe saddle having a pipe compression pad suitable for sealing engagement with any of a range of different diameter irrigation pipes with the pipe saddle having pliable pipe straps integrally formed to the compression pad to provide a continuous surface for compressive engagement of an external surface of an irrigation pipe thereto to thereby hold an irrigation pipe in position within the pipe saddle while a pipe tap is inserted into the irrigation pipe.

### FIELD OF THE INVENTION

This invention relates generally to irrigation and, more specifically, to a pipe saddle that can be mated to different size irrigation pipes.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The art on pipe saddle and branch attachment to irrigation pipes is replete with numerous devices including a saddle for attachment to the irrigation pipe for forming a branch attachment to the irrigation pipe as shown in U.S. Pat. No. 6,767,033. A one-piece saddle tee and coupling tap such as shown in U.S. Pat. No. 5,694,972. A tap and saddle for forming a hinged coupon that can be left in the irrigation pipe as shown in U.S. Pat. No. 6,510,865. A two-step branch forming attachment as shown in U.S. Pat. No. 5,105,844, which shows both the saddle and the tap that forms the branch attachment. Another type of pipe saddle which is usable with a different diameter pipe is shown in U.S. Pat. No. 6,767,033, where the end of the pipe bands contain rigid ends that limit band engagement.

One of the difficulties with pipe saddles is that irrigation systems often have pipes having three or more different diameters as well as being made from two or more different materials. Although one pipe saddle may work with two different diameter irrigation pipes it does not mean that the pipe saddle will work with a range of different diameter irrigation pipes, which are commonly used in installing an irrigation system. As a result an installer usually carries a different size pipe saddle for each diameter irrigation pipe thus requiring a large inventory of pipe saddles. Another difficulty with pipe saddles is that it sometimes difficult to thread a pipe strap into a latch using one hand since the pipe straps are either to rigid or must be forced around the exterior surface of the pipe. A further difficulty is that the process of inserting the pipe tap through the sidewall of the pipe, particularly with larger pipes having thicker sidewalls is that the pressure in piercing the pipe sidewall can cause the latch between the hub and the pipe band to rupture. The present invention provides an improved pipe saddle that eliminates the need to carry an inventory of different size pipe saddles for each size of irrigations pipes as well as facilitates the attachment of various size pipes to a pipe saddle.

### SUMMARY OF THE INVENTION

A pipe saddle having a pipe compression pad suitable for sealing engagement with any of a range of different diameter irrigation pipes with the pipe saddle having pliable pipe straps integrally formed to the compression pad to provide a continuous surface for compressive engagement of an external surface of an irrigation pipe thereto to thereby hold an irrigation pipe in an engaged position within the pipe saddle while a pipe tap is inserted into the irrigation pipe.

### BRIEF DESCRIPTION OF THE DRAWINGS

FIG. 1 is a side view of the irrigation pipe saddle;

FIG. 2 is a sectional view of the hub of the irrigation pipe saddle in engagement with the flexible strap of the irrigation pipe saddle;

FIG. 3 is a sectional view of the irrigation pipe saddle of FIG. 1;

FIG. 4 is a bottom view of the irrigation pipe saddle taken along lines 4-4 of FIG. 1;

FIG. 5 is an end view of the irrigation pipe saddle in engagement with a pipe of a first diameter; and

FIG. 6 is an end view of the irrigation pipe saddle in engagement with an irrigation pipe of a second diameter.

### DESCRIPTION OF THE PREFERRED EMBODIMENT

FIG. 1 shows a side view of a one-piece polymer plastic pipe saddle 10 for attachment to any of a number of irrigation pipes of different diameters. Pipe saddle 10 includes a rigid cylindrical housing or receptacle 11 for rotationally receiving a pipe penetrating tool that can form an opening in a pipe held in receptacle 11. Such pipe penetrating tools are more fully described in U.S. King et al U.S. Pat. Nos. 6,510,865 and 5,105,844 which are hereby incorporated by reference.

Extending laterally from one side of a rigid pipe compression pad 12, which is located on the bottom of receptacle 11, is a first resilient pipe strap 13 having a plurality of teeth 13a thereon and extending from the opposite side of the rigid pipe compression pad 12 is a second shorter resilient pipe strap 14 having a latching hub 15 secured to the end thereof. Pipe compression pad 12 has a curved or arcuate surface shape to engage an exterior radiused surface of a pipe. In the embodiment shown the pipe compression pad 12 has a fixed radius of curvature R that extends a distance x as shown in FIG. 1 and FIG. 4. FIG. 4 shows that pipe compression pad 12 has a side boundary, which is identified by dashed line 12a, and that side boundary 12a forms an integral continuous junction with an end of the pipe strap 14. Similarly, an outer boundary identified by dashed line 12b on the opposite side of pipe compression pad also forms an integral continuous junction with an end of the pipe strap 13. While both the pipe straps 13 and 14 and the pipe compression pad 12 are made from the same material the thinness of the pipe straps 13 and 14 allows them to be flexed in response to a force while the structure of the receptacle 11 and pad 12 reinforce each to provide a rigid support. Thus compression pad 12 provides a rigid structure or rigid pipe compression pad 12 for clamping engagement to an external surface of a pipe in the region where a pipe tap is to be inserted through the sidewall of the pipe while the thinner pipe straps are pliable to conform to the exterior surface of a pipe.

FIG. 1 shows an inside pipe engaging surface 13c of strap 13, an inside pipe engaging surface 14c of strap 14 and the pipe engaging surface 12c of compression pad 12 forming a smooth and continuous surface for engaging the exterior surface of an irrigation pipe. The continuous surface enhances the ability of a single pipe saddle to accommodate pipes of different diameters since the pipe can be more easily deformed to the shape of the compression pad.

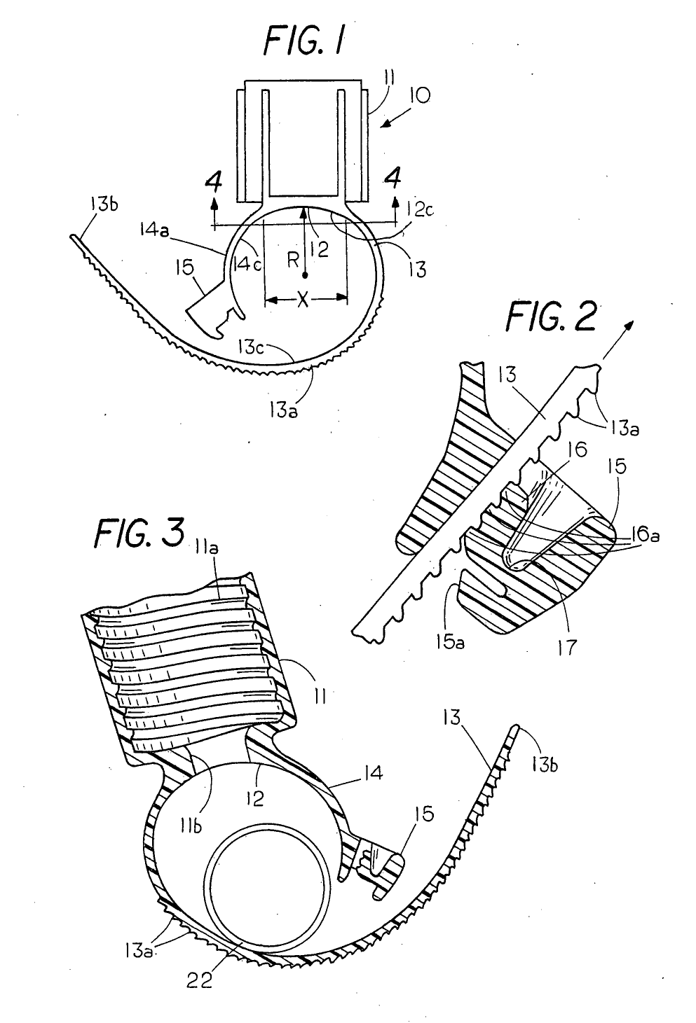

In order to hold the irrigation pipe while an opening is formed in the irrigation pipe the pipe strap 13 includes a plurality of teeth 13a for forming latching engagement with a latch member 16 in hub 15. (FIG. 2) In operation the flexible strap 13 and flexible strap 14, which are integrally joined to compression pad 12, are placed around the peripheral region of an irrigation pipe. The multiple teeth 13a provide for accommodation of the pipe saddle to various size pipes and the multiple teeth.

To enhance the ability of pipe saddle 10 to accommodate pipes of different diameters, strap 13 is sufficiently pliable so as to continuously conform to an external surface of an irrigation pipe secured therein when the pipe strap 13 is latched to hub 15. To further enhance the ability of pipe saddle 10 to accommodate pipes of different diameters strap 13, a set of teeth 13a extend lengthwise along strap 13 so that different size pipes can be secured by a single pipe strap. In the embodiment shown the set of teeth 13a extend at least 50% of the length of the first resilient strap to enable the strap 13 to accommodate a number of different size pipes. While the length of the teeth on the strap can vary based on the size of the pipes generally the length of the teeth on the strap 13 should be sufficient so that when the largest pipe is used there are sufficient teeth to enable securing the pipe to the pipe saddle with at least one tooth and preferably three teeth.

Pipe strap 14 includes a closed end hub 15 which is secured to the end of the resilient strap 14. The hub 15 includes a latch 16 (FIG. 2) for forming latching engagement with a portion of the set of teeth 13a that extend lengthwise along the flexible strap 13. The coaction of the teeth 13a and the latch 16 enable the flexible strap 13, the flexible strap 14 and the compression pad 12 to be conformably secured to an irrigation pipe wherein the irrigation pipe can have a diameter within a range of diameters.

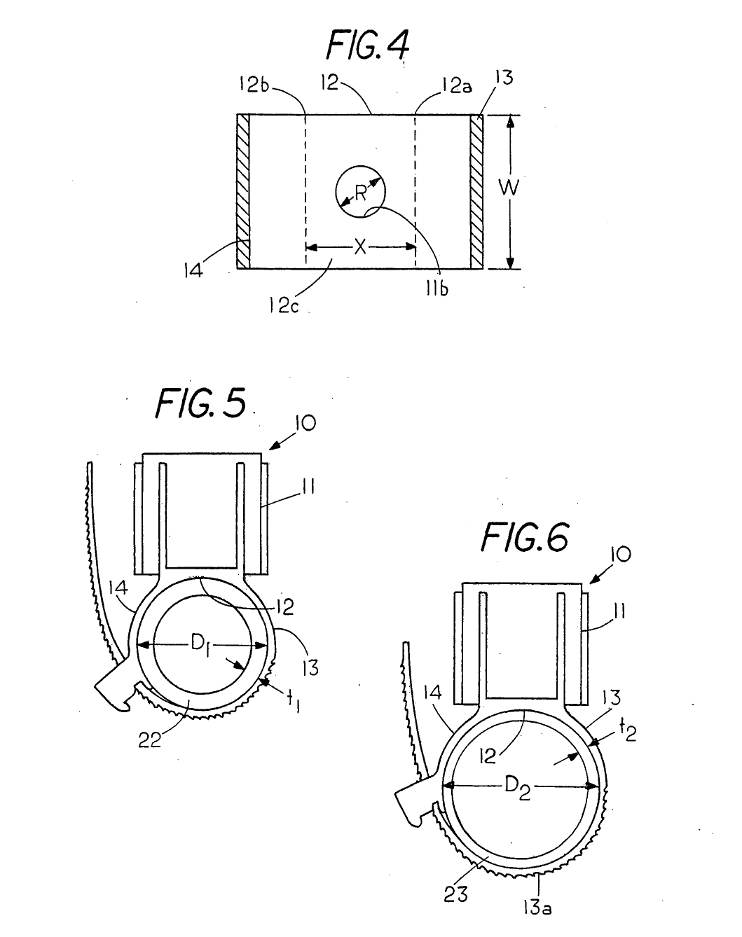

FIG. 2 is an isolated sectional view of hub 15 showing the teeth 13a on the flexible band 13 in engagement with a set of three teeth 16a on a cantilever latch 16 that is secured to hub 15 through a living hinge 17 that can flex to allow multiple teeth 16a on latch 16 and multiple teeth 13a on pipe strap 13 to slide past each other when pipe strap 13 is pulled in the direction of the arrow but prevents teeth 13a and teeth 16a from sliding past each other in the opposite direction thus maintaining the pipe saddle 10 in a latched condition on an irrigation pipe as shown in FIG. 5 and FIG. 6.

A further feature of the pipe saddle 10 can be found in FIG. 1 which shows the pipe saddle in an unmounted condition with the integral resilient pipe strap 13 having an upward curve to form a smooth cradle for placing and resting an irrigation pipe 22 along pipe strap 13 before the irrigation pipe 22 is secured to the pipe saddle 10. That is, the arcuate pipe strap 13 can be extended around the exterior of a pipe 22 and the resiliency of the pipe strap 13 causes the strap 13 to extend upward in a cradling condition around a pipe as shown in FIG. 3. With pipe strap 13 extending upward in a cradling condition it facilitates the one hand securement of the pipe strap 13 to the latch 16 in hub 15 since a user can grasp the pipe saddle 10 in one hand and use his or her fingers to guide the free end 13b of the pipe strap 13 into the hub 15 while the resiliency of the strap 13 provides a force that aids in extending the pipe strap 13 into and through the hub 15 while the smooth cradle allows the pipe to smoothly slide into the engaged position shown in FIG. 5 and FIG. 6.

In addition to the resilient pipe strap 13 having an integral continuous, smooth curve the resilient pipe strap 13 is sufficiently pliable so that the strap 13 can be snugly wrapped around conventional irrigation pipes of at least three substantially different diameters when coupled to pipe strap 14. That is, the compression pad 12 and the pipe straps 13 and 14 coact with each other to enable the pad 12 and pipe straps 13 and 14 to snugly engage and contact substantially an entire circumferential region of a pipe so that a pipe tool can be inserted into the receptacle 11. For example, FIG. 5 shows the pipe strap 13 and pipe strap 14 fitted around a circumferential region of pipe 22 of Diameter D₁ of ¾ inch and thickness t₁ and FIG. 6 shows the pipe strap 13 and pipe strap 14 fitted around a circumferential region of pipe 23 of diameter D₂ of I and ¼ inches and thickness t₂. In each case the compression pad 12 smoothly engages the external surface of the pipe to allow the irrigation pipe saddle to be securable to an irrigation pipe having a range of diameters from ¾ inch to 1 and ¼ inch even though the radius of curvature R of the pipe is different from the radius of curvature or either pipe 22 or 23. In addition pipe compression pad 12 is also engageable with pipes of intermediate diameter, for example a pipe having a one-inch diameter. Pipe 22 and pipe 23 having a diameter of ¾ inch pipe or 1 and ¼ inch diameter have been described since such diameter pipes are typical of standard size pipes used in the irrigation industry; however, the pipe saddle 10 is also sealingly engageable with pipes of non standard sizes.

Although the compression pad 12 is rigid, FIG. 5 and FIG. 6 show the irrigation pipe can be conformed to the shape of the compression pad 12 since the pipe straps 13 and 14 and compression pad 12 can circumferential engage substantially an entire circumferential region of the pipe. The coaction of resilient pipe straps 13 and 14 with pad 12 allow one to apply radial pressure to the exterior surface of the irrigation pipe thereby in essence fitting either of pipe 22 or 23 to the compression pad 12 even though the radius of curvature of pipe 22 and pipe 23 are different than the radius of curvature R of the compression pad. While the resilient pipe straps are preferred it is understood that in some instance the invention may be practiced without resilient pipe straps.

In general, the pipe compression pad 12 has a radius of curvature R that is between a radius of curvature R₁ of a smallest diameter irrigation pipe that can be successfully mounted in pipe saddle 10 and the radius of curvature R₂ of the largest diameter pipe that can be successfully mounted in pipe saddle and preferably the radius of curvature of the pipe compression pad R is midway between the radius of curvature of the smallest diameter irrigation pipe R₁ and the radius of curvature R₂of the largest diameter pipe. To enhance the securement of the pipe saddle 10 to various diameter pipes the width x of the compression pad is minimized but still includes lateral pad regions on the side of the opening 11b. By minimizing the lateral pad regions the pliability of strap 13 and strap 14 can be utilized to snugly secure the pipe saddle to a pipe without rupture of the straps 13 and 14. That is, by minimizing the width of the compression pad one minimizes the distortion of the irrigation pipe when the irrigation pipe has a different radius of curvature than the radius of curvature of the compression pad 12.

As FIG. 1 shows the pipe engaging pad 12 has a radius of curvature R. To allow the pipe saddle 10 to be used with irrigation pipes having a range of diameters the radius of curvature R of the curvature of the pipe compression pad 12 is ideally selected so it is at the midpoint of the desired range. For example, if one intends to use pipe saddle 10 with irrigation pipes ranging in diameter from ¾ inch to 1 and ¼ inches one selects a radius of curvature R for the compression pad 12 that corresponds to a radius of curvature R for a 1 inch diameter pipe. By utilizing a midpoint radius of curvature one can ensure that the compression pad 12 will be in tight sealing engagement with the external surface of a pipe located therein as long as the pipe is within the specified range. Although selection of a mid point of a range is preferable if one desires the radius of curvature can be selected so as to range with a variety of different size pipes.

We claim:

1. A one-piece irrigation pipe saddle for attachment to a irrigation pipes of different diameters comprising:
a receptacle for receiving a pipe penetrating tool;
a pipe compression pad having a first outer boundary and a second outer boundary, said rigid pipe compression pad having an opening therein for insertion of a tool therethrough;
a first resilient strap integrally secured to the first outer boundary of the pipe compression pad to form a continuous pipe engaging surface therewith;
a set of teeth extending in a lengthwise direction along the first resilient strap;
a second resilient strap integrally secured to the second outer boundary of the pipe compression pad to form a further continuous pipe engagement surface therewith; and
a hub secured to said second resilient strap for forming latching engagement with a portion of the set of teeth on the first flexible strap to enable the first flexible strap and the second flexible strap and the compression pad to be sealingly secured to an irrigation pipe wherein the irrigation pipe can have a diameter within a range of diameters.

2. The irrigation pipe saddle of claim 1 wherein the range of diameters extends from ¾ inch diameter to 1 and ¼ inch diameter.

3. The irrigation pipe saddle of claim 1 wherein the first resilient strap has an integral arcuate shape to form a cradle for holding a pipe therein.

3. The irrigation pipe saddle of claim 1 wherein the pipe compression pad has a radius of curvature that is sealable to an irrigation pipe that has a radius of between is a radius of curvature of a smallest diameter irrigation pipe and the radius of curvature of a largest diameter pipe that are both within the range of diameters.

4. The irrigation pipe saddle of claim 3 wherein the radius of curvature of the pipe compression pad is midway between the radius of curvature of the smallest diameter irrigation pipe and the radius of curvature of the largest diameter pipe that are both within the range of diameters.

5. The irrigation pipe saddle of claim 1 wherein the hub includes a guide for directing a free end of the pipe strap into engagement with a set of teeth on a latch in the hub.

6. The irrigation pipe saddle of claim 4 wherein the latch in the hub is integrally secured thereto with a living hinge.

7. The irrigation pipe saddle of claim 5 wherein the latch includes a base larger than a top of the latch to enhance engagement of the strap to the latch.

8. The irrigation saddle of claim 1 wherein the set of teeth extend at least 50% of the length of the first resilient strap.

9. The irrigation saddle of claim 1 wherein the first resilient strap is sufficiently pliable to continuously conform to an external surface of an irrigation pipe secured therein when the first resilient strap is latched to said hub.

10. A method of securing a pipe saddle to at least one of three different diameter irrigation pipes comprising:
placing a pliable pipe strap around an irrigation pipe having a first radius of curvature;
placing a pipe compression pad having a radius of curvature different from the first radius of curvature on the irrigation pipe; and
bringing the compression pad and integrally formed pipe straps into engagement with the irrigation pipe by extending the pliable pipe strap through a hub on a further pipe strap and pulling on the pliable pipe strap.

11. The method of claim 10 including the step of extending a set of teeth on a latch into engagement with a set of teeth on the pliable pipe strap.

12. The method of claim 10 including the step of placing the irrigation pipe in a cradle formed by a one of the integrally formed pliable pipe straps before bringing the compression pad and the integrally formed pliable pipe strap into engagement with the irrigation pipe.

13. The method of claim 12 wherein a living hinge on a hub is pivoted to permit passage of a set of teeth through the hub.

14. The method of claim 13 wherein a ramp guides an end of the pliable pipe strap into the hub.

15. A branched irrigation line comprising:
a pipe saddle;
a housing, said housing having a pipe shoulder with a radius of curvature R; a first flex strap having a plurality of teeth thereon with said first flexible strap extending from a first side of the pipe shoulder;
a second flexible strap extending from an opposite side of said pipe shoulder, said second flexible strap having a hub thereon for locking engaging at least one tooth in the plurality of teeth;
an irrigation pipe secured proximate the pipe shoulder by said first flexible strap and said second flexible strap, said pipe having a radius of curvature R₁ where R₁ is greater or lesser than R.

16. The branched irrigation line of claim 15 wherein the irrigation pipe comprises polyethylene tubing.

17. The branched irrigation line of claim 15 wherein the irrigation pipe comprises PVC.

18. The branched irrigation line of claim 15 wherein the hub includes a latch with a living hinge.

19. The branched irrigation line of claim 18 wherein the latch includes a cantilevered guide ramp.

20. The branched irrigation line of claim 18 wherein at least three teeth on the hub are in engagement with at least three teeth on the first flexible strap.
